(19) United States
(12) Patent Application Publication
(10) Pub. No.: US 2025/0027898 A1
(43) Pub. Date: Jan. 23, 2025

(54) CAPACITOR AND ANALYSING DEVICE

(71) Applicant: Nippon Telegraph and Telephone corporation, Tokyo (JP)

(72) Inventors: Kenta Fukada, Tokyo (JP); Suzuyo Inoue, Tokyo (JP); Tomomi Murai, Tokyo (JP); Takuro Tajima, Tokyo (JP); Michiko Seyama, Tokyo (JP)

(21) Appl. No.: 18/715,242

(22) PCT Filed: Feb. 1, 2022
(86) PCT No.: PCT/JP2022/003787

§ 371 Date: May 31, 2024

(51) Int. Cl. G01N 27/22

(52) U.S. Cl. CPC G01N 27/226; G01N 27/221

(57) ABSTRACT

A capacitor includes a first electrode and a second electrode arranged to face each other, and a gel structure arranged to be sandwiched between the first electrode and the second electrode. The gel structure is made of a hydrogel containing a reactant that reacts with a target substance which is an analysis target to generate a gas. The first electrode and the second electrode each include an insulating layer formed to cover respective surfaces facing each other. The gel structure is sandwiched between the first electrode and the second electrode via the insulating layers.

### CROSS-REFERENCE TO RELATED APPLICATIONS

This application is a national phase entry of PCT Application No. PCT/JP2022/003787, filed on Feb. 1, 2022, which application is hereby incorporated herein by reference.

### TECHNICAL FIELD

The present invention relates to a capacitor of which a capacitance is changed mainly due to presence of a target substance present in a living body, and an analysis device using the capacitor.

### BACKGROUND

For example, a biosensor including an enzyme reaction responsive capacitor and a resonance circuit to analyze a target substance in a living body has been proposed (Non Patent Literature 1). In this research (technology), a substance that is decomposed by an enzyme is disposed between electrodes included in a capacitor. In this report, a capacitor filled with a subtilisin enzyme and collagen between electrodes is produced.

By using a biosensor using this capacitor, for example, calcium which is a target substance can be analyzed. When the above-described capacitor is brought into contact with an aqueous solution in which calcium which is a measurement target is dissolved, collagen (inter-electrode substance) is decomposed in association with an enzymatic reaction, a solution flows between the two electrodes from the generated gap, and a dielectric constant and an electrostatic capacitance are changed. Magnitude of this change corresponds to a calcium concentration in the aqueous solution. Accordingly, calcium can be analyzed by reading a change in a resonant frequency of an RLC circuit tag by magnetic coupling via an external coil.

### CITATION LIST

### Non Patent Literature

Non Patent Literature 1: N. F. Reuel et al., “Hydrolytic Enzymes as (Bio)-Logic for Wireless and Chipless Biosensors”, American Chemical Society Sensors, vol. 1, pp. 348-353, 2016.

### SUMMARY

### Technical Problem

However, in the above-described technology, since the dielectric constant between the electrodes is changed by decomposition (breakdown) of an inter-electrode substance and an inflow of the solution associated with a reaction with a target substance, a capacitor structure is likely to be damaged and not to function as a capacitor.

Embodiments of the present invention have been devised to solve the foregoing problem, and an object of embodiments of the present invention is to change a capacitance by a reaction of a target substance of an inter-electrode substance without damaging a capacitor structure.

### Solution to Problem

According to embodiments of an aspect of the present invention, a capacitor includes: first and second electrodes arranged to face each other; a gel structure made of a hydrogel containing a reactant that is disposed to be sandwiched between the first and second electrodes and reacts with a target substance which is a target to generate a gas; and insulating layers formed to cover surfaces of the first and second electrodes facing each other.

The analysis device according to embodiments of the present invention includes the above-described capacitor and analyzes the target substance.

### Advantageous Effects of Embodiments of the Invention

As described above, according to embodiments of the present invention, since a gel structure formed of the hydrogel containing a reactant that reacts with the target substance to generate a gas is disposed between the first and second electrodes via the insulating layer, the capacitance can be changed by the reaction of the target substance of the inter-electrode substance without damaging the capacitor structure.

### BRIEF DESCRIPTION OF THE DRAWINGS

FIG. 1 is a sectional view illustrating a configuration of a capacitor according to an embodiment of the present invention.

FIG. 2A is a perspective view illustrating a state of the capacitor in an intermediate step to describe a method of manufacturing the capacitor according to the embodiment of the present invention.

FIG. 2B is a perspective view illustrating a state of the capacitor in an intermediate step to describe the method of manufacturing the capacitor according to the embodiment of the present invention.

FIG. 2C is a perspective view illustrating a state of the capacitor in an intermediate step to describe the method of manufacturing the capacitor according to the embodiment of the present invention.

FIG. 2D is a perspective view illustrating a state of the capacitor in an intermediate step to describe the method of manufacturing the capacitor according to the embodiment of the present invention.

FIG. 2E is a perspective view illustrating a state of the capacitor in an intermediate step to describe the method of manufacturing the capacitor according to the embodiment of the present invention.

FIG. 2F is a perspective view illustrating a state of the capacitor in an intermediate step to describe the method of manufacturing the capacitor according to the embodiment of the present invention.

FIG. 2G is a perspective view illustrating a state of the capacitor in an intermediate step to describe the method of manufacturing the capacitor according to the embodiment of the present invention.

FIG. 2H is a perspective view illustrating a state of the capacitor in an intermediate step to describe the method of manufacturing the capacitor according to the embodiment of the present invention.

FIG. 3 is a characteristic diagram illustrating a measurement result of a change in electrostatic capacitance of a capacitor in association with an enzymatic reaction.

FIG. 4A is a characteristic diagram illustrating a result obtained by evaluating activity of an enzyme in an aqueous solution.

FIG. 4B is a characteristic diagram illustrating the result obtained by evaluating activity of an enzyme in a hydrogel.

FIG. 5A is a characteristic diagram illustrating a measurement result of an S parameter in a resonance circuit including a capacitor.

FIG. 5B is a characteristic diagram illustrating an observation result of resonance in a configuration in which a material containing an aqueous electrolyte solution is sandwiched by a capacitor with an electrode protected by a water-repellent insulating tape.

FIG. 6 is a configuration diagram illustrating a configuration of an analysis device according to an embodiment of the present invention.

FIG. 7A is a characteristic diagram illustrating a measurement result of electrostatic capacitance of a capacitor 100 brought into contact with a hydrogen peroxide solution.

FIG. 7B is a characteristic diagram illustrating a measurement result of a resonant frequency of the resonance circuit by capacitor 100 and antenna coil 105.

### DETAILED DESCRIPTION OF ILLUSTRATIVE EMBODIMENTS

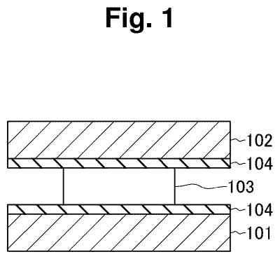

Hereinafter, a capacitor according to an embodiment of the present invention will be described with reference to FIG. 1. The capacitor includes a first electrode 101 and a second electrode 102 arranged to face each other, and a gel structure 103 arranged to be sandwiched between the first electrode 101 and the second electrode 102. The first electrode 101 and the second electrode 102 can be made of, for example, a metal such as gold, zinc, or magnesium.

The gel structure 103 is made of a hydrogel containing a reactant that reacts with a target substance which is an analysis target to generate a gas. The hydrogel can be, for example, a food material such as gelatin, chitosan, or agar. The hydrogel can be a gel of agarose, a polyion complex (anion cation polymer), a polymer of tetramethylenediamine, or a polymer (Tetra-PEG) using tetrafunctional polyethylene glycol (PEG) as a prepolymer.

The reactant is made of a material suitable for a living body. The reactant can be made of, for example, an enzyme of a target substance. The enzyme can be, for example, catalase (present in a human body, a liver, or the like), glucose oxidase (present in honey or the like), cholesterol oxidase, urease, or the like.

The first electrode 101 and the second electrode 102 include an insulating layer 104 formed to cover surfaces facing each other. The gel structure 103 is sandwiched between the first electrode 101 and the second electrode 102 via the insulating layers 104. The gel structure 103 is formed by being adhered to the surfaces of the first electrode 101 and the second electrode 102 facing each other, where the insulating layers 104 are formed, via the insulating layers 104. Each insulating layer 104 can be formed to cover the entire surface of each of the first electrode 101 and the second electrode 102.

The insulating layer 104 is made of a material suitable for a living body. The insulating layer 104 can be made of, for example, beeswax. The insulating layer 104 can be made of a mixture of beeswax and a lubricating oil such as olive oil or almond oil.

When the capacitor according to the embodiment is immersed in an aqueous solution in which there is a substance (molecule) which is an analysis target, the aqueous solution penetrates into a gap between the first electrode 101 and the second electrode 102 by, for example, a capillary force or the like. As a result, the aqueous solution comes into contact with the gel structure 103, and the molecule which is an analysis target can react with and the enzyme of the gel structure 103, and this reaction arises between the first electrode 101 and the second electrode 102.

With this reaction, bubbles are generated in the gel structure 103. A dielectric constant of the bubbles is approximately 1, and the dielectric constant (mixed dielectric constant) of the gel structure 103 decreases due to the generation of the air bubbles. The volume of the gel structure 103 increases due to the generation of bubbles, and the gap between the first electrode 101 and the second electrode 102 is changed (spreads). When this change is also added, the capacitance between the first electrode 101 and the second electrode 102 is further changed. This change results in a change of the capacitance between the first electrode 101 and the second electrode 102, and can be measured as an electric signal.

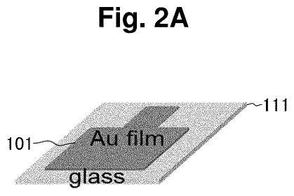

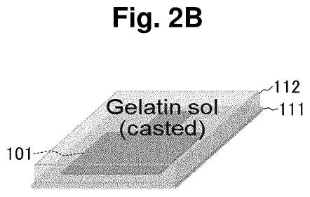

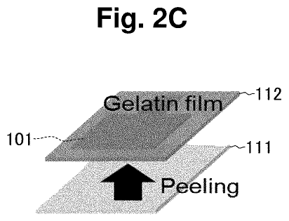

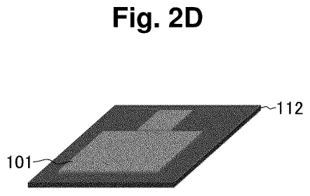

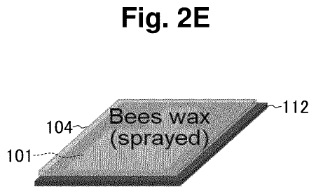

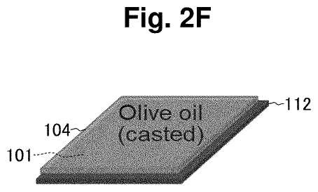

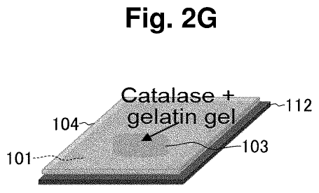

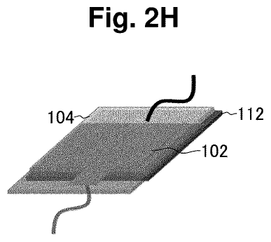

Here, a method of manufacturing the capacitor according to the embodiment will be described with reference to FIGS. 2A to 2H. First, as illustrated in FIG. 2A, a gold thin film is formed on a glass plate 111 by a sputtering method or a vapor deposition method to form a first electrode 101. Subsequently, as illustrated in FIG. 2B, a gel film 112 made of gelatin or the like is formed on the glass plate 111 to cover the first electrode 101, and is dried for 24 hours. Subsequently, as illustrated in FIG. 2C, the glass plate 111 is separated from the first electrode 101 and the gel film 112. As illustrated in FIG. 2D, the first electrode 101 is formed on the gel film 112.

Subsequently, acetone in which beeswax is dispersed is blown (sprayed) to form the insulating layer 104 on the first electrode 101, as illustrated in FIG. 2E. Subsequently, as illustrated in FIG. 2F, olive oil is added dropwise to the insulating layer 104 and mixed. Subsequently, a sol of gelatin mixed with an enzyme is dropped onto the insulating layer 104 and gelatinized to form a columnar gel structure 103, as illustrated in FIG. 2G. Subsequently, the second electrode 102 produced similarly to the production of the above-described first electrode 101 is disposed on the gel structure 103. An insulating layer is also formed on the surface of the second electrode 102. Thereafter, a wiring is connected to each of the first electrode 101 and the second electrode 102.

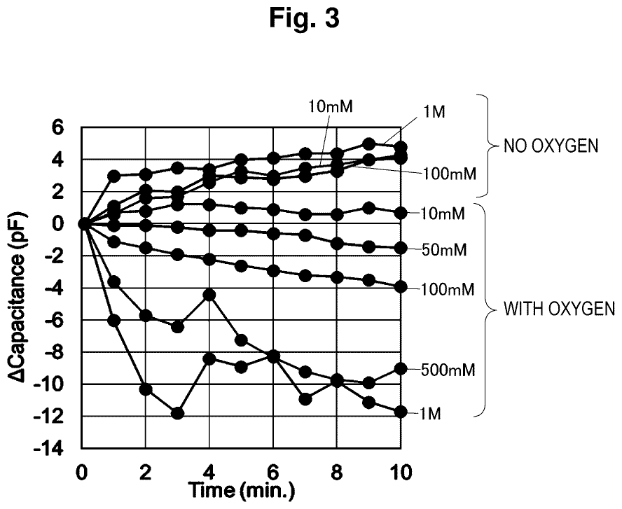

Next, a measurement result of the change in electrostatic capacitance associated with an enzymatic reaction will be described with reference to FIG. 3. In this measurement, a gold electrode that has an area of approximately 1 cm2 is formed on a glass substrate, and two electrode substrates to which an insulating tape is attached are prepared. Gelatin sol containing catalase at a concentration of 0.05% catalase was dropped (5 mL) on an insulating tape of one electrode substrate to form a gelatin structure. The gelatine structure was adhered to an insulating tape of the other electrode substrate to form a capacitor. The gelatin structure was a cylinder that has a diameter of 2 mm and a height (thickness) of 800 μm.

When the above-described capacitor is immersed in hydrogen peroxide water as an example of measurement, bubbles of oxygen gas are generated in the gelatin structure due to a reaction between hydrogen peroxide and catalase. It is considered that a mixed dielectric constant εr of the bubbles (dielectric constant is about 1) of oxygen which are a reaction product and a measurement solution (dielectric constant is about 80) penetrating between the electrodes decreases with the generation of the bubbles. It is considered that an inter-electrode distance (a thickness of the gelatin structure) d increases because a gap between the electrodes is expanded with the generation of the bubbles. As an actual measurement result, the thickness of the gelatin structure increased from 800 μm to 900 μm.

The electrostatic capacitance C is expressed with “C=εo×εr×(S÷d)” when εo is a capacitance in vacuum in the electrode area S. The changes in the thickness d of the gelatin structure and in the mixed dielectric constant εr are a phenomenon in which the capacitance C decreases together, and thus it is expected that the electrostatic capacitance of the capacitor decreases due to an enzymatic reaction.

As illustrated in FIG. 3, in the actual measurement result, it was confirmed that a temporal change in electrostatic capacitance arising according to a concentration of hydrogen peroxide, and the capacitance certainly decreased. Since a slope of this change varies depending on the concentration of hydrogen peroxide, the concentration of hydrogen peroxide can be estimated from the slope.

For example, since hydrogen peroxide is generated from glucose, cholesterol, and the like by using an oxidase, it is considered that the concentration of these substances can be estimated in the same principle. In addition, since ammonia and carbon dioxide are generated by a reaction of urease with urea, it is considered that a concentration can be estimated by generating bubbles in the same principle.

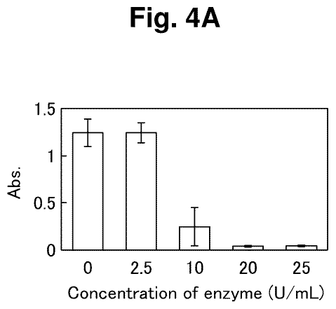

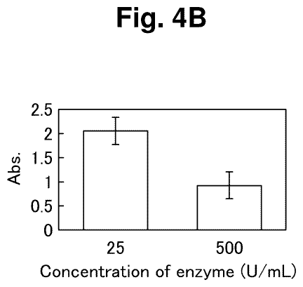

Results obtained by evaluating activity of the enzyme in an aqueous solution and in a hydrogel are illustrated in FIGS. 4A and 4B. When the enzyme is contained in the hydrogel, activity to a concentration decreases, compared to a case where the enzyme is dispersed in the aqueous solution. When the concentration of the enzyme is 25 U/mL, Abs.=0.042 in the aqueous solution as illustrated in FIG. 4A whereas Abs.=2.064 in the hydrogel as illustrated in FIG. 4B. Thus, there is a difference of 49.1 times in activity.

In a configuration in which enzyme is contained in a gel, a decrease in a contact area between the enzyme and a target sample is considered to be the above-described cause. However, as can be understood from the comparison between the enzyme concentrations of 25 U/mL and 500 U/mL as illustrated in FIG. 4B, an amount of chemical reaction required to generate a gas can be guaranteed by increasing a content of the enzyme. It can be said that the enzyme reaction can be caused only between the electrodes of the capacitor by adopting a method of immobilizing the enzyme in the hydrogel.

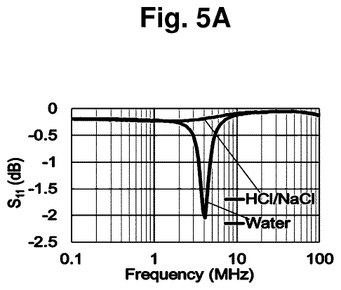

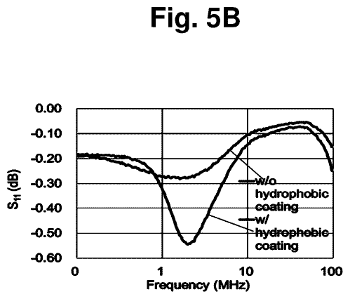

Incidentally, in analysis of the ecosystem, the aqueous solution which is a target is an aqueous solution in which the electrolyte is dissolved. When the electrolyte aqueous solution penetrates a gap between the electrodes of the capacitor, an insulating property cannot be maintained, and thus it becomes difficult to function as the capacitor. A measurement result of the S parameter in the resonance circuit including the capacitor is illustrated in FIG. 5A. In the aqueous electrolyte solution (HCl/NaCl), a local minimum value does not appear.

In order to cause the aqueous electrolyte solution to function as a capacitor in a state where the aqueous electrolyte solution is between the electrodes, it is necessary to insulate the surfaces of the electrodes. When the electrode is protected with a water-repellent insulating tape, resonance can be observed even in a configuration in which a substance containing an aqueous electrolyte solution is sandwiched, as illustrated in FIG. 5B.

In order to prevent the aqueous solution from coming into contact with the electrode, it is desirable to form an insulating film having water repellency (large contact angle) on the electrode. However, for example, in the case of a fine capacitor, when the surfaces of the electrodes arranged facing each other are water-repellent, a capillary force (a small contact angle is required) does not arise in these minute spaces. In this state, the aqueous solution which is an analysis target cannot be introduced between the electrodes and brought into contact with the gel structure disposed between the electrodes.

On the other hand, by forming a small contact angle with the aqueous solution and forming the insulating layer from a material that repels the droplets, it is possible to allow the aqueous solution which is an analysis target to penetrate the gap between the electrodes while maintaining the insulating property. For example, by mixing beeswax with olive oil or the like, an insulating layer having the above-described function can be obtained. When the minute space is coated with a water-repellent agent, a capillary force does not occur. However, according to the insulating layer in which beeswax and olive oil are mixed, a capillary phenomenon substantially similar to that of the hydrophilic film occurs in the minute space, and it is considered that droplets can be drawn into the gap.

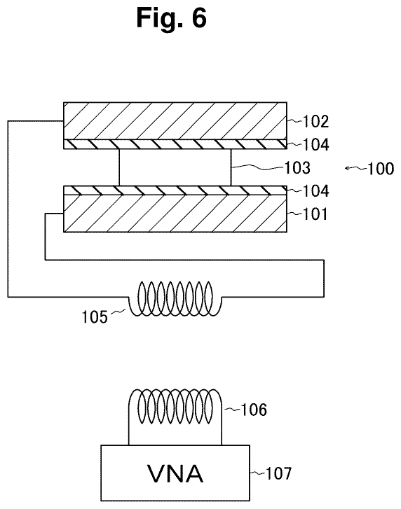

Next, the analysis device according to the embodiment of the present invention will be described with reference to FIG. 6. The analysis device includes the capacitor 100 according to the above-described embodiment and analyzes a target substance. The analysis device includes the capacitor 100 and an antenna coil 105 included in a resonance circuit. A resonant frequency [f=1/{2π(LC)1/2}] of the resonance circuit including the capacitor 100 and the antenna coil 105 is coupled to, for example, the coil 106 disposed with a distance of 1 mm and measured by a vector network analyzer (VNA) 107.

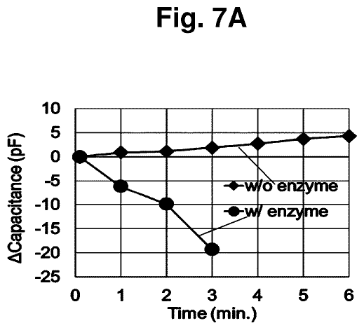

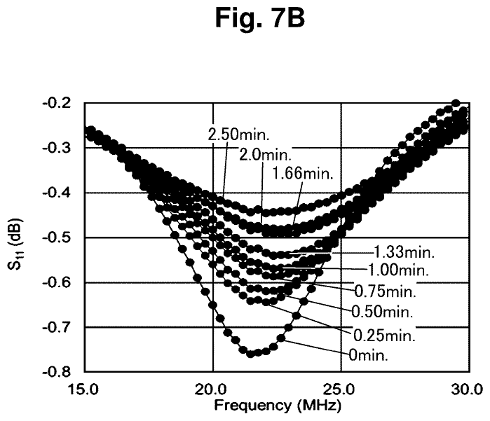

A measurement result obtained from the VNA 107 is illustrated in FIG. 7A. The gel structure 103 contained enzyme, and the analysis target was hydrogen peroxide water (100 mM). It can be confirmed that the capacitance of capacitor 100 changes over time by a reaction between hydrogen peroxide and the enzyme contained in the gel structure 103 (black circles). Due to the presence of the insulating layer 104, contact between the first electrode 101 and the second electrode 102, and the hydrogen peroxide solution is prevented. Thus, it is achieved that the hydrogen peroxide solution which is a measurement target penetrates the gap between the electrodes due to the capillary phenomenon and comes into contact with the gel structure 103.

In the above-described analysis, when the resonant frequency of the resonance circuit by the capacitor 100 and the antenna coil 105 is observed (measured), as illustrated in FIG. 7B, the resonant frequency is shifted in a direction in which the resonant frequency increases over time (with lapse of time) due to the reaction with hydrogen peroxide. This is a tendency to match the change in the resonant frequency when the capacitance of the capacitor 100 decreases. Since the shift of the resonant frequency relates to a change in the capacitance of the capacitor 100, a concentration of a measurement sample can be estimated by observing the change in the resonant frequency per time.

As described above, according to embodiments of the present invention, since the gel structure formed of the hydrogel containing the reactant that reacts with the target substance to generate a gas is disposed between the first electrode and the second electrode via the insulating layer, the capacitance can be changed by the reaction of the target substance of the inter-electrode substance without damaging the capacitor structure.

By using the above-described capacitor, for example, if the reactant is an enzyme, analysis with high specificity for the enzyme reaction can be performed. The capacitor can be used in a living body such as a swallowed sensor or an embedded sensor since the capacitor is made of a biocompatible material. For example, when an RLC circuit is formed in combination with an antenna coil in addition to the capacitor to form an analysis device, the analysis device can be used to estimate a state in a body by reading a change in resonant frequency from the outside of the body by magnetic coupling.

The above-described capacitor can also be used for measurement in water (an external stimulus-responding gel is selected to measure ions, pH, or the like in environments such as water quality investigation, hydroponic cultivation, and aquaculture.) or monitoring of a food production line by using a biodegradable material.

The present invention is not limited to the above-described embodiment, and it is apparent that various modifications and combinations can be implemented by those skilled in the art without departing from the technical spirit of the present invention.

### REFERENCE SIGNS LIST

101 First electrode
102 Second electrode
103 Gel structure
104 Insulating layer

1.-8. (canceled)

9. A capacitor comprising:
a first electrode;
a second electrode, wherein a first surface of the first electrode faces a second surface of the second electrode;
a gel structure made of a hydrogel containing a reactant that is disposed between the first and second electrodes, wherein the gel structure is configured to react with a target substance which is a target to generate a gas;
a first insulating layer covering the first surface of the first electrode; and
a second insulating layer covering the second surface of the second electrode.

10. The capacitor according to claim 9, wherein
the gel structure is adhered to the first insulating layer and the second insulating layer.

11. The capacitor according to claim 10, wherein:
the first insulating layer covers an entirety of the first surface of the first electrode; and
the second insulating layer covers an entirety of the second surface of the second electrode.

12. The capacitor according claim 10, wherein:
the reactant, the first insulating layer, and the second insulating layer are made of a biocompatible material.

13. The capacitor according to claim 9, wherein:
the first insulating layer covers an entirety of the first surface of the first electrode; and
the second insulating layer covers an entirety of the second surface of the second electrode.

14. The capacitor according claim 13, wherein:
the reactant, the first insulating layer, and the second insulating layer are made of a biocompatible material.

15. The capacitor according claim 9, wherein:
the reactant, the first insulating layer, and the second insulating layer are each made of a biocompatible material.

16. The capacitor according to claim 15, wherein
the reactant is made of an enzyme of the target substance.

17. The capacitor according to claim 16, wherein
the first insulating layer and the second insulating layer is made of beeswax.

18. The capacitor according to claim 14, wherein
the first insulating layer and the second insulating layer is made of beeswax.

19. An analysis device comprising:
a capacitor comprising:
a first electrode;
a second electrode, wherein a first surface of the first electrode faces a second surface of the second electrode;
a gel structure made of a hydrogel containing a reactant that is disposed between the first and second electrodes, wherein the gel structure is configured to react with a target substance which is a target to generate a gas;
a first insulating layer covering the first surface of the first electrode; and
a second insulating layer covering the second surface of the second electrode,
wherein the analysis device is configured to analyze the target substance to estimate a concentration of the target substance.

20. The analysis device according to claim 19, further comprising: a coil included in a resonance circuit along with the capacitor.

21. The analysis device according to claim 19, wherein
the gel structure is adhered to the first insulating layer and the second insulating layer.

22. The analysis device according to claim 19, wherein:
the first insulating layer covers an entirety of the first surface of the first electrode; and
the second insulating layer covers an entirety of the second surface of the second electrode.

23. The analysis device according to claim 19, wherein:
the reactant, the first insulating layer, and the second insulating layer are made of a biocompatible material.

24. The analysis device according to claim 23, wherein
the reactant is made of an enzyme of the target substance.

25. The analysis device according to claim 23, wherein
the first insulating layer and the second insulating layer is made of beeswax.
